(19) United States
(12) Patent Application Publication
(10) Pub. No.: US 2008/0093036 A1
(43) Pub. Date: Apr. 24, 2008

(54) SLAT FOR A WINDOW BLIND

(76) Inventor: Ya-Yin Lin, Chia-Yi Hsien (TW)

Correspondence Address: BANNER & WITCOFF, LTD., 1100 13th STREET, N.W., SUITE 1200, WASHINGTON, DC, 20005-4051, US

(21) Appl. No.: 11/551,399

(22) Filed: Oct. 20, 2006

(51) Int. Cl. E06B 3/12

(52) U.S. Cl. 160/236

(57) ABSTRACT

A slat for a window blind includes a slat body made of a foamed plastic, and at least one reinforcing rib embedded in the slat body. The reinforcing rib is made of a non-foamed plastic, and extends along the length of the slat body so as to enhance the overall strength of the slat body.

### BACKGROUND OF THE INVENTION

1. Field of the Invention

The invention relates to a slat, more particularly to a slat for a window blind.

2. Description of the Related Art

A conventional slat for a window blind is made of a foamed material in order to reduce cost and weight. However, the slat made of the foamed material is very soft, so that the slat sags when hung horizontally.

In U.S. Pat. Nos. 6,083,601 and DES409869, a protective cladding made of a non-foamed plastic is extruded and is covered around a foamed core of a window blind slat so as to strengthen the slat, thereby preventing the slat from sagging when hung horizontally. The slat exiting an extrusion machine is cut to appropriate lengths in response to customer requirements. However, after cutting, the end faces of the slat are plain and therefore aesthetically unappealing.

### SUMMARY OF THE INVENTION

Therefore, the object of the present invention is to provide a slat for a window blind that has a strong structure and that has end faces which can be provided with various designs.

According to this invention, a slat for a window blind comprises a slat body made of a foamed plastic, and at least one reinforcing rib embedded in the slat body. The reinforcing rib is made of a non-foamed plastic, and extends along the length of the slat body.

### BRIEF DESCRIPTION OF THE DRAWINGS

Other features and advantages of the present invention will become apparent in the following detailed description of the preferred embodiments with reference to the accompanying drawings, of which:

FIG. 1 is a fragmentary perspective view of the first preferred embodiment of a slat for a window blind according to the present invention;

FIG. 2 is a fragmentary partly sectional view of the first preferred embodiment;

FIG. 3 is a fragmentary perspective view of the second preferred embodiment of a slat for a window blind according to the present invention;

FIG. 4 is a fragmentary partly sectional view of the third preferred embodiment of a slat for a window blind according to the present invention; and

FIG. 5 is a fragmentary partly sectional view of the fourth preferred embodiment of a slat for a window blind according to the present invention.

### DETAILED DESCRIPTION OF THE PREFERRED EMBODIMENTS

Before the present invention is described in greater detail, it should be noted that like elements are denoted by the same reference numerals throughout the disclosure.

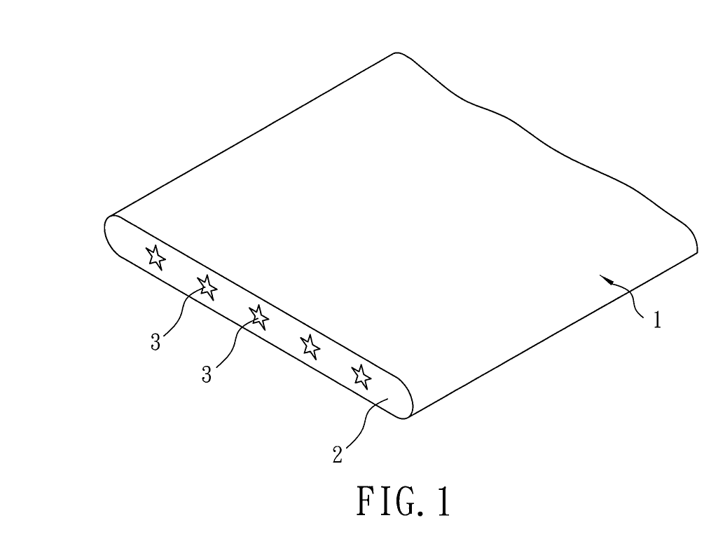

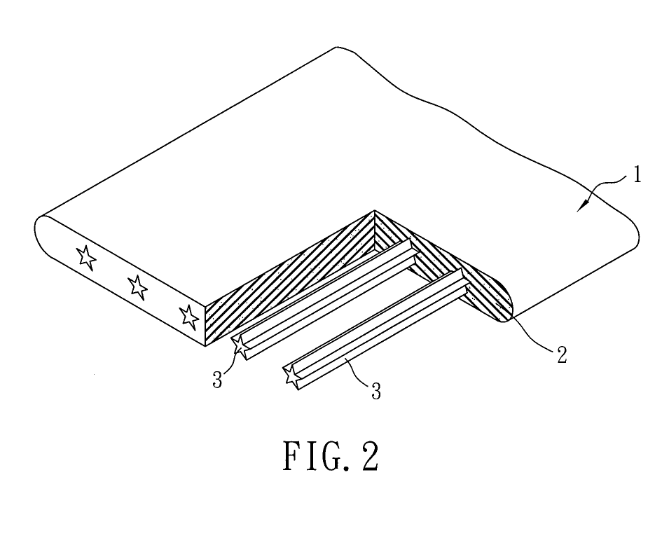

Referring to FIGS. 1 and 2, the first preferred embodiment of a slat 1 for a window blind according to the present invention is shown to comprise a slat body 2, and a plurality of elongated reinforcing ribs 3.

The slat body 2 is made from a foamed plastic, and is a non-transparent body.

The reinforcing ribs 3 are embedded in the slat body 2 at intervals, and extend along the length of the slat body 2. The reinforcing ribs 3 are made from a non-foamed plastic. In this embodiment, each of the reinforcing ribs 3 has a substantially star-shaped cross section. Alternatively, each reinforcing rib 3 may have a circular, oval, square, or rectangular cross section.

The reinforcing ribs 3 and the slat body 2 are formed as a unitary body. As the reinforcing ribs 3 reinforce the slat body 2, the strength of the slat 1 is enhanced to thereby prevent the slat 1 from sagging when hung horizontally.

The slat 1 is formed by co-extruding the foamed plastic and the non-foamed plastic through a plastic extruding machine to form a continuous strip which is thereafter cut into a plurality of slats 1.

Further, the appearance of the slat 1 is enhanced through the presence of the star-shaped cross section of the reinforcing ribs 3 on two opposite end faces of the slat 1.

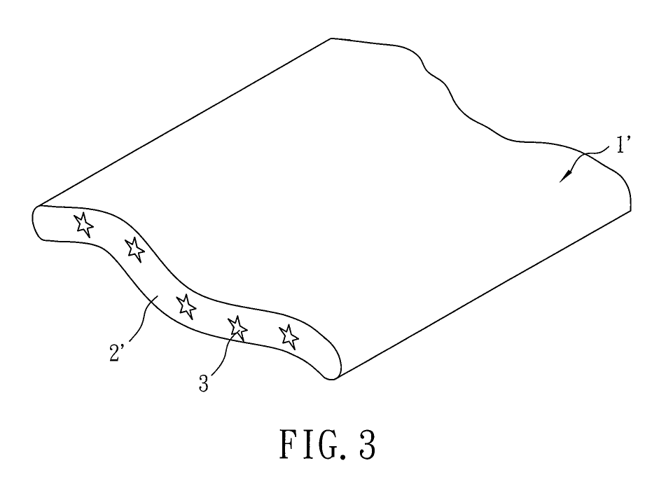

Referring to FIG. 3, a second preferred embodiment of a slat 1′ for a window blind according to the present invention is shown to be similar to the first preferred embodiment. However, in this embodiment, the slat body 2′ has a wavy cross section.

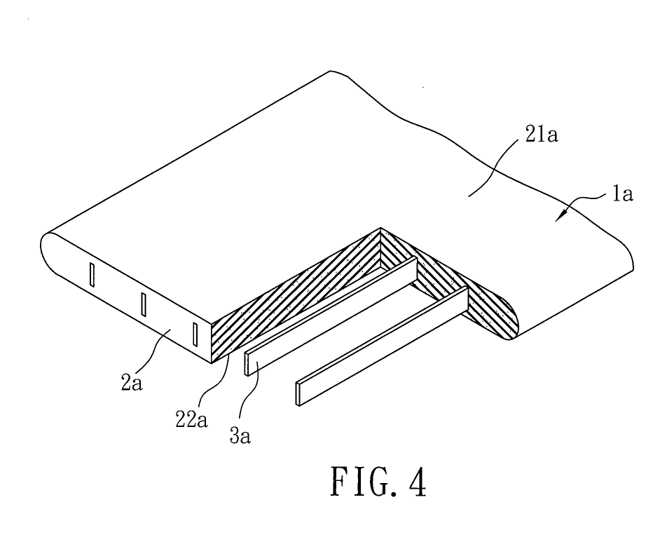

Referring to FIG. 4, a third preferred embodiment of a slat (1a) for a window blind according to the present invention is shown to be similar to the first preferred embodiment. However, in this embodiment, the reinforcing ribs (3a) are formed as plates that extend between and that are transverse to two opposite surfaces (21a, 22a) of the slat body (2a).

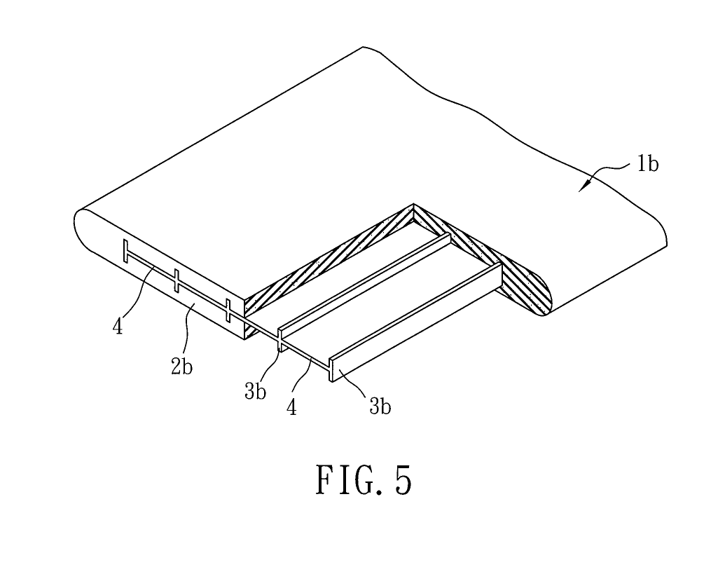

Referring to FIG. 5, a fourth preferred embodiment of a slat (1b) for a window blind according to the present invention is shown to be similar to the third preferred embodiment. However, in this embodiment, the slat (1b) further comprises a plurality of cross plates 4 each interconnecting two adjacent ones of the plates or reinforcing ribs (3b). The cross plates 4 and the reinforcing ribs (3b) are formed as a unitary body, thereby further enhancing the overall strength of the slat body (2b) of the present invention.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A slat for a window blind comprising:
a slat body made of a foamed plastic; and
at least one reinforcing rib embedded in said slat body, said reinforcing rib being made of a non-foamed plastic and extending along the length of said slat body.

2. The slat of claim 1, wherein a plurality of said reinforcing ribs are embedded in said slat body at intervals.

3. The slat of claim 2, wherein each of said reinforcing ribs has a substantially star-shaped cross section.

4. The slat of claim 3, wherein said slat body has a wavy cross section.

5. The slat of claim 2, wherein said slat body has two opposite surfaces, said reinforcing ribs being formed as plates that extend between and that are transverse to said surfaces.

6. The slat of claim 5, further comprising a plurality of cross plates each interconnecting two adjacent ones of said plates.
